(19) United States
(12) Patent Application Publication
(10) Pub. No.: US 2019/0332804 A1
(43) Pub. Date: Oct. 31, 2019

(54) METHOD FOR INFORMATION PROCESSING, DEVICE, SERVER AND STORAGE MEDIUM

(71) Applicant: BAIDU ONLINE NETWORK TECHNOLOGY (BEIJING) CO., LTD., Beijing (CN)

(72) Inventor: Tianyu QI, Beijing (CN)

(21) Appl. No.: 16/508,417

(22) Filed: Jul. 11, 2019

(30) Foreign Application Priority Data
Aug. 6, 2018 (CN) 201810886489.5

(51) Int. Cl. G06F 21/62; G06K 9/46; H04L 29/06; G06K 9/00

(52) U.S. Cl. CPC G06F 21/6245; G06K 9/4609; G06K 9/00275; G06K 9/00234; H04L 63/101

(57) ABSTRACT

Provided are a method for information processing, a device, a server and a storage medium. The method includes: receiving scan information uploaded by a terminal; extracting an external feature of a target person from the scan information; matching the external feature of the target person with a picture in a pre-stored augmented reality AR business card to obtain a target AR business card corresponding to the target person; and sending the target AR business card to the terminal. The method can efficiently and conveniently obtain information of a stranger that is wished to be a friend, which makes the way of making friends more flexible.

### CROSS-REFERENCE TO RELATED APPLICATIONS

This application claims priority to Chinese Patent Application No. CN201810886489.5, filed on Aug. 6, 2018, which is incorporated herein by reference in its entirety.

### TECHNICAL FIELD

The present disclosure relates to the field of network communication technology, and in particular, to a method for information processing, a device, a server and a storage medium.

### BACKGROUND

With the development of terminal technology and Internet technology, people can conveniently use a communication software loaded in a terminal or use a social network application to make friends.

At present, general social network applications (such as WeChat, QQ, Momo, etc.) need to rely on friend information or account number to add friends when establishing a friend relationship with a stranger.

However, in the actual process of making friends, it is not necessary to have an opportunity to ask a stranger for friend information or account number, which makes that the existing methods are unable to efficiently and conveniently obtain information of the stranger that is wished to be a friend, the flexibility of way of making friends is poor and the efficiency is low.

### SUMMARY

The present disclosure provides a method for information processing, a device, a server and a storage medium, which can efficiently and conveniently obtain information of a stranger that is wished to be a friend, which makes the way of making friends more flexible.

In a first aspect, an embodiment of the present disclosure provides a method for information processing, including:

receiving scan information uploaded by a terminal;

extracting an external feature of a target person from the scan information;

matching the external feature of the target person with a picture in a pre-stored augmented reality (AR) business card to obtain a target AR business card corresponding to the target person; and

sending the target AR business card to the terminal.

In a possible design, before the receiving scan information uploaded by a terminal, the method further includes:

receiving a registration request sent by the terminal;

displaying an information editing page on the terminal according to the registration request;

generating an AR business card according to text information and picture information edited by a user on the information editing page; and

storing the AR business card.

In a possible design, after the generating an AR business card according to text information and picture information edited by a user on the information editing page, the method further includes:

receiving operation information sent by the user through the terminal;

performing any one or more of the following operations according to the operation information:

performing an update operation on at least one of the text information and the picture information in the AR business card, where the update operation includes: adding, deleting and modifying; and

setting different levels of visible permissions for at least one of the text information and the picture information in the AR business card, where the visible permissions include: only visible to oneself, only visible to a preset group, and public to all.

In a possible design, the external feature of the target person includes: a face feature, a clothing feature and a wearing article feature.

In a possible design, the matching the external feature of the target person with a picture in a pre-stored augmented reality AR business card to obtain a target AR business card corresponding to the target person includes:

extracting a reference feature from a picture corresponding to the pre-stored AR business card, where the reference feature includes: a face feature, a clothing feature and a wearing article feature; and

comparing the external feature of the target person with the reference feature, and taking a corresponding AR business card as a target AR business card if a similarity of the comparison is greater than a preset threshold.

In a possible design, the method further includes:

sending to the terminal a prompt message indicating that the matching fails, when the number of the target AR business card is zero; and

sending to the terminal a target AR business card having a highest similarity, when the number of the target AR business cards is greater than 1.

In a possible design, after the sending the target AR business card to the terminal, the method further includes:

receiving a friend request sent by the terminal according to the target AR business card; and

forwarding the friend request to a user corresponding to the target AR business card, or recommending an AR business card of a corresponding user of the terminal to the user corresponding to the target AR business card.

In a second aspect, an embodiment of the present disclosure provides a device for information processing, including:

a receiving module, configured to receive scan information uploaded by a terminal;

an extracting module, configured to extract an external feature of a target person from the scan information;

a matching module, configured to match the external feature of the target person with a picture in a pre-stored augmented reality AR business card to obtain a target AR business card corresponding to the target person; and

a sending module, configured to send the target AR business card to the terminal.

In a possible design, the device further includes a processing module;

the processing module is configured to:

receive a registration request sent by the terminal before receiving the scan information uploaded by the terminal;

display an information editing page on the terminal according to the registration request;

generate an AR business card according to text information and picture information edited by a user on the information editing page; and

storing the AR business card.

In a possible design, the processing module is further configured to:

receive operation information sent by the user through the terminal, after generating the AR business card according to the text information and the picture information edited by the user on the information editing page; and

perform any one or more of the following operations according to the operation information:

perform an update operation on at least one of the text information and the picture information in the AR business card, where the update operation includes: adding, deleting and modifying; and

set different levels of visible permissions for at least one of the text information and the picture information in the AR business card, where the visible permissions include: only visible to oneself, only visible to a preset group, and public to all.

In a possible design, the external feature of the target person includes: a face feature, a clothing feature and a wearing article feature.

In a possible design, the matching module is specifically configured to:

extract a reference feature from a picture corresponding to the pre-stored AR business card, where the reference feature includes: a face feature, a clothing feature and a wearing article feature; and

compare the external feature of the target person with the reference feature, and take a corresponding AR business card as a target AR business card if a similarity of the comparison is greater than a preset threshold.

In a possible design, the sending module is further configured to:

send to the terminal a prompt message indicating that the matching fails, when the number of the target AR business card is zero; and

send to the terminal a target AR business card having a highest similarity, when the number of the target AR business cards is greater than 1.

In a possible design, the receiving module is further configured to receive a friend request sent by the terminal according to the target AR business card after sending the target AR business card to the terminal; and

the sending module is further configured to forward the friend request to a user corresponding to the target AR business card, or recommend an AR business card of a corresponding user of the terminal to the user corresponding to the target AR business card.

In a third aspect, an embodiment of the present disclosure provides a server, including: a processor and a memory, an executable instruction of the processor being stored in the memory, where the processor is configured to execute, by executing the executable instruction, the method for information processing according to any one of embodiments of the first aspect.

According to a fourth aspect, an embodiment of the present disclosure provides a computer readable storage medium, storing a computer program, where the program implements the method for information processing according to any one of embodiments of the first aspect, when the program is executed by a processor.

In a fifth aspect, an embodiment of the present disclosure provides a program product, where the program product includes a computer program, the computer program is stored in a readable storage medium, at least one processor of a server can read the computer program from the readable storage medium, the at least one processor executes the computer program so that the server implements the method for information processing according to any one of embodiments of the first aspect of the present disclosure.

According to the method and device for information processing, the server and the storage medium provided by the present disclosure, by receiving scan information uploaded by a terminal; extracting an external feature of a target person from the scan information; matching the external feature of the target person with a picture in a pre-stored augmented reality AR business card to obtain a target AR business card corresponding to the target person; and sending the target AR business card to the terminal, information of a stranger that is wished to be a friend can be obtained efficiently and conveniently and thus the way of making friends is more flexible.

### BRIEF DESCRIPTION OF DRAWINGS

In order to more clearly illustrate embodiments of the present disclosure or the technical solutions in the prior art, the drawings used in the embodiments or the prior art description will be briefly described below. Obviously, the drawings in the following description are some embodiments of the present disclosure, and for those skilled in the art, other drawings can be obtained according to these drawings without any creative effort.

FIG. 1 is a schematic principle diagram of an application scenario of the present disclosure;

FIG. 2 is a flowchart of a method for information processing according to Embodiment I of the present disclosure;

FIG. 3 is a flowchart of a method for information processing according to Embodiment II of the present disclosure;

FIG. 4 is a schematic structural diagram of a device for information processing according to Embodiment III of the present disclosure;

FIG. 5 is a schematic structural diagram of a device for information processing according to Embodiment IV of the present disclosure; and

FIG. 6 is a schematic structural diagram of a server according to Embodiment V of the present disclosure.

### DESCRIPTION OF EMBODIMENTS

In order to make purposes, technical solutions and advantages of the embodiments of the present disclosure clearer, the technical solutions in the embodiments of the present disclosure will be clearly and completely described below in conjunction with the accompanying drawings of the embodiments of the present disclosure. It is apparent that the described embodiments are some embodiments of the present disclosure, and not all embodiments. All other embodiments obtained by those skilled in the art based on the embodiments of the present disclosure without creative efforts are within the scope of the present disclosure.

The terms “first”, “second”, “third”, “fourth”, etc. (if present) in the specification and claims of the present disclosure as well as the above accompanying drawings are used to distinguish similar objects without having to use to describe a specific order. It is to be understood that such data as used may be interchanged as appropriate, so that the embodiments of the present disclosure described here can be implemented, for example, in a sequence other than those illustrated or described herein. In addition, the terms “includes” and “have” and any variant thereof are intended to cover a non-exclusive inclusion, for example, a process, method, system, product, or device that includes a series of steps or units is not necessarily limited to those steps or units explicitly listed, but may include other steps or units not explicitly listed or inherent to the process, method, system, product or device.

The technical solutions of the present disclosure will be described in detail below with reference to specific embodiments. The following specific embodiments may be combined with each other, and the same or similar concept or process maybe is not repeated in some embodiments.

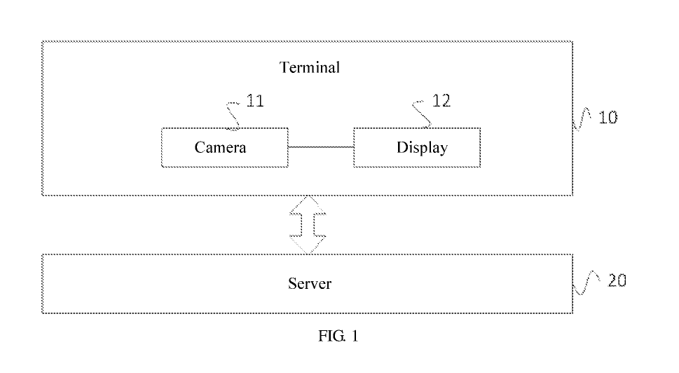

FIG. 1 is a schematic principle diagram of an application scenario of the present disclosure. As shown in FIG. 1, first, a terminal 10 scans a face, clothing, a wearing article, etc. of a stranger to be added by a camera 11 to obtain corresponding scan information (or directly take a photo containing an external feature such as the face, the clothing, the wearing article, etc. of the stranger). The terminal 10 uploads the scanned information (or the photo) to a server 20. The server 20 extracts the external feature of the stranger from the scanned information (or the photo), and the external feature includes: a face features, a clothing feature, a wearing article feature, and the like. The server 20 matches the extracted external feature with a feature of a picture in a pre-stored augmented reality (AR) business card to obtain a target AR business card corresponding to the stranger; and sends the target AR business card to the terminal 10. The terminal 10 displays the target AR business card on a display 12. In this embodiment, an AR business card of the stranger pre-stored in the server 20 can be obtained by scanning the external feature of the stranger, thereby avoiding an embarrassment of obtaining a contact way when making friends, and improving an efficiency of obtaining the contact way of the stranger, and the user can also freely edit the AR business card, avoiding leakage of privacy and having high flexibility.

The technical solutions of the present disclosure and how the technical solutions of the present disclosure solve the above technical problem will be described in detail below with reference to specific embodiments. The following specific embodiments may be combined with each other, and the same or similar concept or process may not be repeated in some embodiments. Embodiments of the present disclosure will be described below with reference to the accompanying drawings.

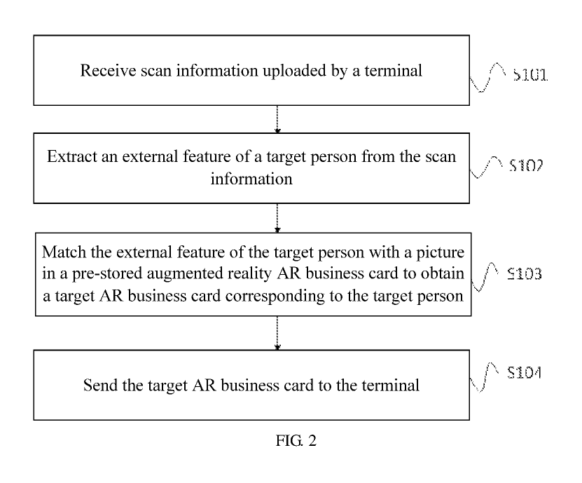

FIG. 2 is a flowchart of a method for information processing according to Embodiment I of the present disclosure. As shown in FIG. 2, the method in this embodiment may include:

S101: receive scan information uploaded by a terminal.

In this embodiment, the terminal may be a smart device with a camera and a display, such as a smart phone, a tablet computer, or the like. A user can scan a face, clothing, a wearing article, etc. of a stranger to be added by a camera of a terminal, to obtain corresponding scan information (or directly take a photo containing an external feature such as the face, the clothing, the wearing article, etc. of the stranger). The terminal uploads the scanned information (or the photo) to a server.

In an optional embodiment, a terminal side may establish a data interaction with the server by an installed social application, and the server manages information of a successfully registered user. In use, the user can open the social application loaded in the terminal, and then send the scanned information (or the photo) obtained by the camera to the server through the social application.

S102: extract an external feature of a target person from the scan information.

In this embodiment, the server extracts the external feature of the target person from the scanned information (or the photo), and the external feature of the target person include: a face feature, a clothing feature and a wearing article feature. It should be noted that in this embodiment, the target person refers to a friend that the user intends to make, and the augmented reality (AR) business card corresponding to the target person is used as a target AR business card.

Specifically, the AR technology, i.e., augmented reality, in the embodiment is also referred to as mixed reality, which can apply virtual information to a real world by a computer technology, and a real environment and a virtual object are superimposed onto the same screen in real-time or their spaces exist at the same time. In this embodiment, the AR technology is used to present the user's business card. It should be noted that, in this embodiment, the information included in the business card is not limited. Specifically, the AR business card may include multimedia information such as text, audio and picture.

S103: match the external feature of the target person with a picture in a pre-stored augmented reality AR business card to obtain a target AR business card corresponding to the target person.

In an optional implementation manner, before receiving the scan information uploaded by the terminal, a registration request sent by the terminal is first received; an information editing page is displayed on the terminal according to the registration request; an AR business card is generated according to text information and picture information edited by the user on the information editing page; and the AR business card is stored. Optionally, operation information sent by the user through the terminal may be received; and any one or more of the following operations are performed according to the operation information: performing an update operation on at least one of the text information and the picture information in the AR business card, where the update operation includes: adding, deleting and modifying; setting different levels of visible permissions on at least one of the text information and the picture information in the AR business card, where the visible permissions include: only visible to oneself, only visible to a preset group and public to all.

In this embodiment, a reference feature is extracted from a picture corresponding to the pre-stored AR business card, and the reference feature includes: a face feature, a clothing feature and a wearing article feature; the external feature of the target character is compared with the reference feature, and if a similarity of the comparison is greater than a preset threshold, then a corresponding AR business card is taken as the target AR business card.

S104: send the target AR business card to the terminal.

In an optional implementation manner, if the number of the target AR business card is zero, then a prompt message indicating that the matching fails is sent to the terminal; and if the number of the target AR business card is greater than 1, then a target AR business card having a highest similarity is sent to the terminal.

Specifically, the method in this embodiment is described in detail in an actual application scenario. It is assumed that both user A and user B have registered information in the server, and the server stores an AR business card of the user A and an AR business card of the user B, where pictures in the AR business card of the user B are an eye picture and a watch picture of the user B. The user A has encountered user B in an accidental encounter, and the user A and the user B have not established a friend relationship in advance. At this time, if the user A intends to add the user B as a friend, then the user A can obtain the AR business card of the user B as follows:

The user A opens a social application in a terminal (for example, a smart phone), and clicks a scanning manner to add a friend in a page of the social application. At this time, a camera of the terminal is turned on, and the user A scans a wearing article (watch) of the user B and a face (may be partial) by the camera and uploads the scanned information to the server. The server extracts the watch picture and the face picture from the scanned information, and compares the watch picture and the face picture with pictures associated with the pre-stored AR business card. Finally the server determines that the pictures in the AR business card of the user B are similar to the pictures in the scanned information uploaded by the user A by more than 80% (can be adjusted according to an actual situation), so the server sends the AR business card of the user B to the terminal of the user A.

In this embodiment, by receiving scan information uploaded by a terminal, extracting an external feature of a target person from the scan information, matching the external feature of the target person with a picture in a pre-stored augmented reality AR business card to obtain a target AR business card corresponding to the target person, and sending the target AR business card to the terminal, it is possible to efficiently and conveniently obtain information of a stranger that is wished to be a friend, and make the way of making friends more flexible.

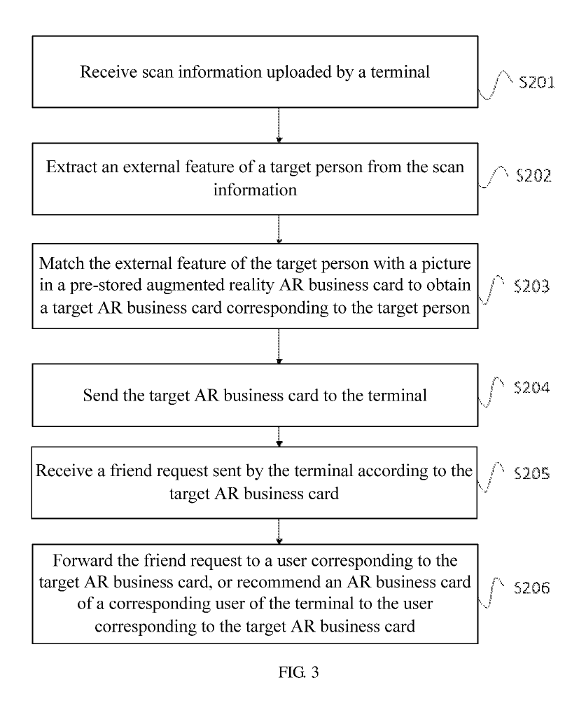

FIG. 3 is a flowchart of a method for information processing according to Embodiment II of the present disclosure. As shown in FIG. 3, the method in this embodiment may include:

S201: receive scan information uploaded by a terminal.

S202: extract an external feature of a target person from the scan information.

S203: match the external feature of the target person with a picture in a pre-stored augmented reality AR business card to obtain a target AR business card corresponding to the target person.

S204: send the target AR business card to the terminal.

For specific implementation processes and technical principles of the steps S201 to S204 in this embodiment, they can refer to the related description in the method shown in FIG. 2, and details are not repeated here.

S205: receive a friend request sent by the terminal according to the target AR business card.

In this embodiment, the terminal may determine an account of the target person according to information on the target AR business card, so that a friend request for the account of the target person may be sent to a server.

S206: forward the friend request to a user corresponding to the target AR business card, or recommend an AR business card of a corresponding user of the terminal to the user corresponding to the target AR business card.

In this embodiment, the server forwards the friend request to a user corresponding to the target AR business card, or recommends an AR business card of a corresponding user of the terminal to the user corresponding to the target AR business card. This avoids the way of directly asking for an account between users to make friends.

Specifically, the method in this embodiment is described in detail in an actual application scenario. It is assumed that both user A and user B have registered information in the server, and the server stores an AR business card of the user A and an AR business card of the user B. At this time, it is assumed that the user A has obtained the AR business card of the user B by scanning Since the user A and the user B have not established a friendship relationship in advance, the user A can only see information disclosed to a stranger in the AR business card of the user B.

Further, the user A finds that the user B is a fellow-villager of himself by viewing the AR business card of the user B. At this time, if the user A intends to add the user B as a friend, then the user A may send a request for adding the user B as a friend to the server in a way of searching for a user account according to an AR business card in a social application. The server forwards the friend request to the user B, or recommends the AR business card of the user A to the user B.

In this embodiment, by receive scan information uploaded by a terminal, extracting an external feature of a target person from the scan information, matching the external feature of the target person with a picture in a pre-stored augmented reality AR business card to obtain a target AR business card corresponding to the target person, and sending the target AR business card to the terminal, it is possible to efficiently and conveniently obtain information of a stranger that is wished to be a friend, and make the way of making friends more flexible, avoiding an embarrassment of getting contact information when making friends and improving an efficiency of obtaining the contact information of the target person, and additionally the user can freely edit an AR business card to avoid leakage of privacy, having high flexibility.

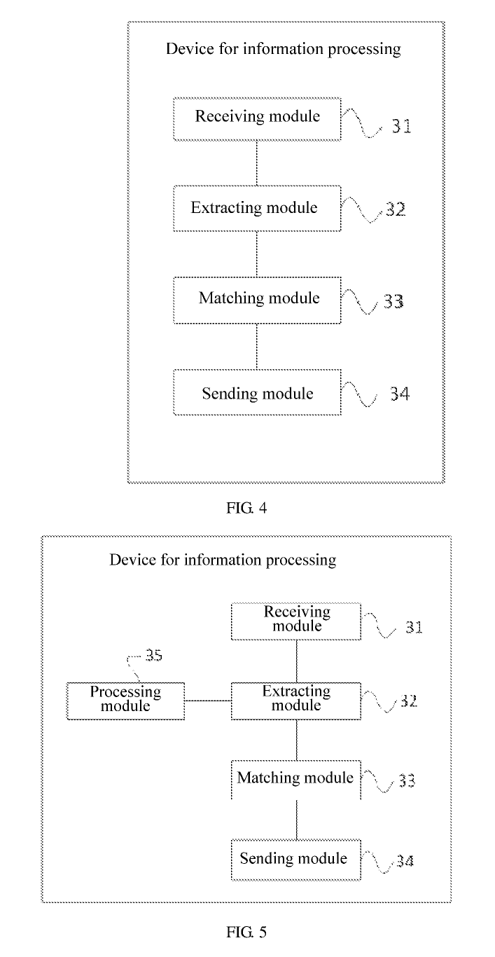

FIG. 4 is a schematic structural diagram of a device for information processing according to Embodiment III of the present disclosure. As shown in FIG. 4, the device for information processing of this embodiment may include:

a receiving module 31, configured to receive scan information uploaded by a terminal;

an extracting module 32, configured to extract an external feature of a target person from the scan information;

a matching module 33, configured to match the external feature of the target person with picture in a pre-stored image augmented reality AR business card to obtain a target AR business card corresponding to the target person; and

a sending module 34, configured to send the target AR business card to the terminal.

In a possible design, the external features of the target person include: a face feature, a clothing feature and a wearing article feature.

In a possible design, the matching module 33 is specifically configured to:

extract a reference feature from a picture corresponding to the pre-stored AR business card, where the reference feature includes: a face feature, a clothing feature and a wearing article feature;

compare the external feature of the target person with the reference feature, and take a corresponding AR business card as a target AR business card if a similarity of the comparison is greater than a preset threshold.

In a possible design, the sending module 34 is further configured to:

send to the terminal a prompt message indicating that the matching fails, when the number of the target AR business card is zero; and

send to the terminal a target AR business card having a highest similarity, when the number of the target AR business card is greater than 1.

In a possible design, the receiving module 31 is further configured to receive a friend request sent by the terminal according to the target AR business card, after sending the target AR business card to the terminal; and

the sending module 34 is further configured to forward the friend request to a user corresponding to the target AR business card, or recommend an AR business card of a corresponding user of the terminal to the user corresponding to the target AR business card.

The device for making friends of the present embodiment can perform the technical solution in the method of any one of the foregoing method embodiments, and has similar implementation principle and technical effect to the method, and details are not repeated here.

FIG. 5 is a schematic structural diagram of a device for information processing according to Embodiment IV of the present disclosure. As shown in FIG. 5, the device for information processing of this embodiment may further include:

a processing module 35, configured to receive a registration request sent by the terminal before receiving the scan information uploaded by the terminal;

display an information editing page on the terminal according to the registration request;

generate an AR business card according to text information and picture information edited by the user on the information editing page; and

store the AR business card.

In a possible design, the processing module 35 is further configured to receive operation information sent by the user through the terminal, after generating the AR business card according to the text information and the picture information edited by the user on the information editing page;

perform any one or more of the following operations according to the operation information;

perform an update operation on at least one of the text information and the picture information in the AR business card, where the update operation includes: adding, deleting and modifying;

setting different levels of visible permissions for at least one of the text information and the picture information in the AR business card, where the visible permissions include: only visible to oneself, only visible to a preset group, and public to all.

The device for making friends of the present embodiment can perform the technical solution in the method of any one of the foregoing method embodiments, and has similar implementation principle and technical effect to the method, and details are not repeated here.

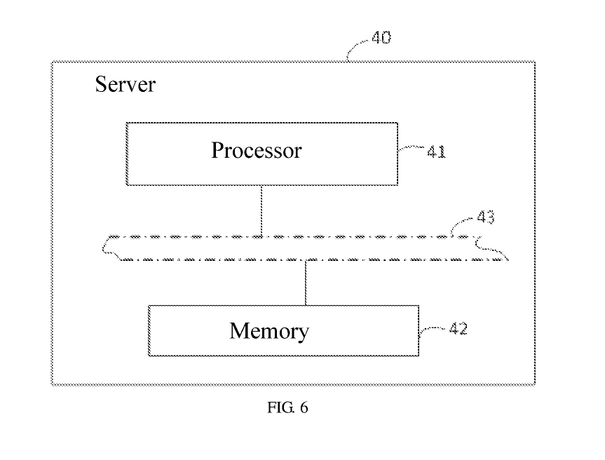

FIG. 6 is a schematic structural diagram of a server according to Embodiment V of the present disclosure. As shown in FIG. 5, a server 40 of this embodiment may include a processor 41 and a memory 42.

The memory 42 is configured to store a computer program (such as an application program, a function module, etc. for implementing the above method for information processing), a computer instruction, and the like, and the above computer program, the computer instruction, and the like may be partitioned and stored in one or more memories 42. And the above computer program, the computer instructions, data, and the like can be called by the processor 41.

The processor 41 is configured to execute the computer program stored by the memory 42 to implement various steps in the methods involved in the foregoing embodiments. For details, refer to the related descriptions in the foregoing method embodiments. The memory 42 and the processor 41 can be coupled by a bus 43.

The server in this embodiment may perform the technical solution in the method of any one of the foregoing method embodiments, and has similar implementation principle and technical effect to the method, and details are not repeated here.

In addition, an embodiment of the present application further provides a computer readable storage medium, storing a computer execution instruction, a user equipment performs the foregoing various possible methods, when at least one processor of the user equipment executes the computer execution instruction.

Where, the computer readable medium includes a computer storage medium and a communication medium, where the communication medium includes any medium that facilitates transfer of a computer program from one location to another. The storage medium may be any available medium that can be accessed by a general purpose or special purpose computer. An exemplary storage medium is coupled to the processor to enable the processor to read information from the storage medium and write information to the storage medium. Of course, the storage medium can be part of the processor. The processor and the storage medium can be located in an application specific integrated circuit (ASIC). Additionally, the ASIC can be located in the user equipment. Of course, the processor and the storage medium may also reside as discrete components in a communication device.

One of ordinary skill in the art will appreciate that all or part of steps to implement various method embodiments described above may be accomplished by a hardware associated with a program instruction. The aforementioned program can be stored in a computer readable storage medium. The program, when executed, performs the steps of the foregoing method embodiments; and the foregoing storage medium includes various media that can store a program code, such as a ROM, a RAM, a magnetic disk, or an optical disk.

Finally, it should be noted that the above embodiments are merely illustrative of the technical solutions of the present disclosure, and are not intended to be limiting; although the present disclosure has been described in detail with reference to the foregoing embodiments, those skilled in the art will understand that the technical solutions described in the foregoing embodiments may be modified, or some or all of the technical features therein may be equivalently replaced; and these modifications or replacements will not make the essence of corresponding technical solutions deviate from the scope of the technical solutions of the embodiments of the present disclosure.

What is claimed is:

1. A method for information processing, comprising:
receiving scan information uploaded by a terminal;
extracting an external feature of a target person from the scan information;
matching the external feature of the target person with a picture in a pre-stored augmented reality (AR) business card to obtain a target AR business card corresponding to the target person; and
sending the target AR business card to the terminal.

2. The method according to claim 1, wherein before the receiving scan information uploaded by a terminal, further comprising:
receiving a registration request sent by the terminal;
displaying an information editing page on the terminal according to the registration request;
generating an AR business card according to text information and picture information edited by a user on the information editing page; and
storing the AR business card.

3. The method according to claim 2, wherein after the generating an AR business card according to text information and picture information edited by a user on the information editing page, further comprising:
receiving operation information sent by the user through the terminal;
performing any one or more of the following operations according to the operation information;
performing an update operation on at least one of the text information and the picture information in the AR business card, wherein the update operation comprises: adding, deleting and modifying; and
setting different levels of visible permissions for at least one of the text information and the picture information in the AR business card, wherein the visible permissions comprise: only visible to oneself, only visible to a preset group, and public to all.

4. The method according to claim 1, wherein the external feature of the target person comprises: a face feature, a clothing feature and a wearing article feature.

5. The method according to claim 1, wherein the matching the external feature of the target person with a picture in a pre-stored AR business card to obtain a target AR business card corresponding to the target person comprises:
extracting a reference feature from a picture corresponding to the pre-stored AR business card, wherein the reference feature comprises: a face feature, a clothing feature and a wearing article feature; and
comparing the external feature of the target person with the reference feature, and taking a corresponding AR business card as the target AR business card if a similarity of the comparison is greater than a preset threshold.

6. The method according to claim 5, further comprising:
sending to the terminal a prompt message indicating that the matching fails, when the number of the target AR business card is zero; and
sending to the terminal a target AR business card having a highest similarity, when the number of the target AR business cards is greater than 1.

7. The method according to claim 1, wherein after the sending the target AR business card to the terminal, further comprising:
receiving a friend request sent by the terminal according to the target AR business card; and
forwarding the friend request to a user corresponding to the target AR business card, or recommending an AR business card of a corresponding user of the terminal to the user corresponding to the target AR business card.

8. A device for information processing, comprising: a processor and a memory storing instructions thereon, the processor, when executing the instructions, being configured to:
receive scan information uploaded by a terminal;
extract an external feature of a target person from the scan information;
match the external feature of the target person with a picture in a pre-stored augmented reality (AR) business card to obtain a target AR business card corresponding to the target person; and
send the target AR business card to the terminal.

9. The device according to claim 8, wherein the processor is further configured to:
receive a registration request sent by the terminal before receiving the scan information uploaded by the terminal;
display an information editing page on the terminal according to the registration request;
generate an AR business card according to text information and picture information edited by a user on the information editing page; and
store the AR business card.

10. The device according to claim 8, wherein the processor is further configured to:
receive operation information sent by the user through the terminal, after generating the AR business card according to the text information and the picture information edited by the user on the information editing page; and
perform any one or more of the following operations according to the operation information:
perform an update operation on at least one of the text information and the picture information in the AR business card, wherein the update operation comprises: adding, deleting and modifying; and
set different levels of visible permissions for at least one of the text information and the picture information in the AR business card, wherein the visible permissions comprise: only visible to oneself, only visible to a preset group, and public to all.

11. The device according to claim 8, wherein the external feature of the target person comprises: a face feature, a clothing feature and a wearing article feature.

12. The device according to claim 8, wherein the processor is further configured to:
extract a reference feature from a picture corresponding to the pre-stored AR business card, wherein the reference feature comprises: a face feature, a clothing feature and a wearing article feature; and
compare the external feature of the target person with the reference feature, and take a corresponding AR business card as the target AR business card if a similarity of the comparison is greater than a preset threshold.

13. The device according to claim 12, wherein the processor is further configured to:
send to the terminal a prompt message indicating that the matching fails, when the number of the target AR business card is zero; and
send to the terminal a target AR business card having a highest similarity, when the number of the target AR business cards is greater than 1.

14. The device according to claim 8, wherein the processor is further configured to:
receive a friend request sent by the terminal according to the target AR business card after sending the target AR business card to the terminal; and
forward the friend request to a user corresponding to the target AR business card, or recommend an AR business card of a corresponding user of the terminal to the user corresponding to the target AR business card.

15. A computer readable storage medium, storing a computer program, and the computer program, when executed by a processor, implements the steps of:
receive scan information uploaded by a terminal;
extract an external feature of a target person from the scan information;
match the external feature of the target person with a picture in a pre-stored augmented reality (AR) business card to obtain a target AR business card corresponding to the target person; and
send the target AR business card to the terminal.

16. The computer readable storage medium according to claim 15, wherein the storage medium further comprises computer execution instruction which, when executed by a processor, implements the steps of:
receive a registration request sent by the terminal before receiving the scan information uploaded by the terminal;
display an information editing page on the terminal according to the registration request;
generate an AR business card according to text information and picture information edited by a user on the information editing page; and
store the AR business card.

17. The computer readable storage medium according to claim 15, wherein the storage medium further comprises computer execution instruction which, when executed by a processor, implements the steps of:
receive operation information sent by the user through the terminal, after generating the AR business card according to the text information and the picture information edited by the user on the information editing page; and
perform any one or more of the following operations according to the operation information:
perform an update operation on at least one of the text information and the picture information in the AR business card, wherein the update operation comprises: adding, deleting and modifying; and
set different levels of visible permissions for at least one of the text information and the picture information in the AR business card, wherein the visible permissions comprise: only visible to oneself, only visible to a preset group, and public to all.

18. The computer readable storage medium according to claim 15, wherein the external feature of the target person comprises: a face feature, a clothing feature and a wearing article feature.

19. The computer readable storage medium according to claim 15, wherein the storage medium further comprises computer execution instruction which, when executed by a processor, implements the steps of:
extract a reference feature from a picture corresponding to the pre-stored AR business card, wherein the reference feature comprises: a face feature, a clothing feature and a wearing article feature; and
compare the external feature of the target person with the reference feature, and take a corresponding AR business card as the target AR business card if a similarity of the comparison is greater than a preset threshold.

20. The computer readable storage medium according to claim 19, wherein the storage medium further comprises computer execution instruction which, when executed by a processor, implements the steps of:
send to the terminal a prompt message indicating that the matching fails, when the number of the target AR business card is zero; and
send to the terminal a target AR business card having a highest similarity, when the number of the target AR business cards is greater than 1.
